(19) United States
(12) Patent Application Publication
(10) Pub. No.: US 2026/0280683 A1
(43) Pub. Date: Sep. 17, 2026

(54) SMTC Shifting for Non-Terrestrial Networks

(71) Applicant: Apple Inc., Cupertino, CA (US)

(72) Inventors: Jie CUI, San Jose, CA (US); Chunxuan YE, San Diego, CA (US); Dawei ZHANG, Saratoga, CA (US); Fangli XU, Beijing (CN); Qiming LI, Beijing (CN); Yang TANG, San Jose, CA (US)

(21) Appl. No.: 19/472,149

(22) PCT Filed: Apr. 5, 2023
(86) PCT No.: PCT/CN2023/086352

§ 371 Date: Oct. 3, 2025

(51) Int. Cl. H04B 7/185

(52) U.S. Cl. CPC H04B 7/18513

(57) ABSTRACT

A user equipment (UE) configured to receive a synchronization signal (SS)/Physical Broadcast Channel (PBCH) block measurement timing information (SMTC) configuration information comprising at least two SMTC windows within an SMTC periodicity, determine an association between a first satellite and a first one of the SMTC windows and a second satellite and a second one of the SMTC windows, receive first SMTC information for the first satellite during the first one of the SMTC windows and second SMTC information for the second satellite during the second one of the SMTC windows and determine a first time shift for the first one of the SMTC windows within the SMTC periodicity based on the first SMTC information and a second time shift for the second one of the SMTC windows within the SMTC periodicity based on the second SMTC information.

### TECHNICAL FIELD

The present disclosure generally relates to wireless communication, and in particular, to SMTC shifting for non-terrestrial networks.

### BACKGROUND

A non-terrestrial network (NTN) refers to a network or a segment of a network which uses an airborne or a space borne vehicle, for example, a satellite, for transmission. The NTN network may provide a user equipment (UE) with SS/PBCH block measurement timing information (SMTC) information periodicity that the UE may use to determine the association between the SMTC information and the satellite. However, due to the constant movement of the satellite, the SMTC periodicity window may not always correspond with the satellite. As a result, the UE may fail to associate the SMTC information with the satellite previously associated with the SMTC information due to the movement of the satellite.

### SUMMARY

Some exemplary embodiments are related to a method performed by a user equipment (UE). The method includes receiving a synchronization signal (SS)/Physical Broadcast Channel (PBCH) block measurement timing information (SMTC) configuration information comprising at least two SMTC windows within an SMTC periodicity, determining an association between a first satellite and a first one of the SMTC windows and a second satellite and a second one of the SMTC windows, receiving first SMTC information for the first satellite during the first one of the SMTC windows and second SMTC information for the second satellite during the second one of the SMTC windows and determining a first time shift for the first one of the SMTC windows within the SMTC periodicity based on the first SMTC information and a second time shift for the second one of the SMTC windows within the SMTC periodicity based on the second SMTC information.

Other exemplary embodiments are related to one or more processors configured to receive a synchronization signal (SS)/Physical Broadcast Channel (PBCH) block measurement timing information (SMTC) configuration information comprising at least two SMTC windows within an SMTC periodicity, determine an association between a first satellite and a first one of the SMTC windows and a second satellite and a second one of the SMTC windows, receive first SMTC information for the first satellite during the first one of the SMTC windows and second SMTC information for the second satellite during the second one of the SMTC windows and determine a first time shift for the first one of the SMTC windows within the SMTC periodicity based on the first SMTC information and a second time shift for the second one of the SMTC windows within the SMTC periodicity based on the second SMTC information.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3A shows a first exemplary scenario where the UE receives SMTC measurement configuration from the network according to various exemplary embodiments.

FIG. 3B shows a second exemplary scenario where the UE receives SMTC measurement configuration from the network and shifts SMTC windows according to various exemplary embodiments.

FIG. 4 shows a third exemplary scenario where the UE performs SMTC window shifting based on the SMTC information received from the network according to various exemplary embodiments.

### DETAILED DESCRIPTION

The exemplary embodiments may be further understood with reference to the following description and the related appended drawings, wherein like elements are provided with the same reference numerals. The exemplary embodiments relate to techniques performed at a user equipment (UE) using SMTC information received from a non-terrestrial network (NTN) to shift the SMTC window associated with a satellite in the trajectory of the satellite to constantly measure the SMTC information associated with that satellite through the trajectory.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component that is capable of connecting to an NTN and performing SMTC shifting in the NTN.

The exemplary embodiments are also described with reference to a SMTC shifting. SMTC shifting occurs when the UE shifts an SMTC window within an SMTC periodicity in the time domain, such that an SMTC window associated with a satellite shifts according to the movement of satellite to ensure that the Satellite can be measured within the SMTC window. In some cases, SMTC windows in an SMTC periodicity may overlap due to the shifting. Accordingly, in the exemplary embodiments, the NTN UE may be configured to shift the SMTC window using various rules to avoid overlapping with other SMTC windows. As will be described herein, in one aspect, the NTN system may transmit SMTC configuration information that may be associated with specific satellites within the SMTC window. In other aspects, the NTN UE may need to determine the association between the SMTC and the satellites within the SMTC window. Based on the SMTC configuration, the NTN UE may be configured to determine which direction to shift the SMTC window(s) to measure the satellites associated with the SMTC window(s) as will be described in more details below.

In 5G NR, the NTN may use an airborne vehicle or a space borne vehicle for transmission. In one example, the airborne vehicle may include a satellite, such as a low earth orbit (LEO) satellite, a medium earth orbit (MEO) satellite, a geosynchronous orbit (GEO) satellite, a highly eccentric orbit (HEO) satellite or another type of satellite. In another example, the space borne vehicle may include high altitude platforms (HAPS).

The exemplary embodiments relate to introducing SMTC configuration information associated with a specific satellite for the UE to allow the UE to perform SMTC shifting in the time domain for the satellite. In other exemplary embodiments, the UE may be configured to perform satellite detection in an SMTC window at a specific time to determine which satellites may be associated with the SMTC window. Based on the satellite detection, the UE may perform a set of operations. In one aspect, the UE may be configured to use a specific satellite as the reference satellite for the SMTC by performing the SMTC shifting based on this reference satellite. In another aspect, the UE may be configured to select the shifting direction of the SMTC window to avoid colliding with other SMTC windows. In a further aspect, the UE may be configured to shift the SMTC window according to the direction of the satellite moving within the SMTC periodicity such that shifting the SMTC window may not cause an overlap with other SMTC windows in the SMTC periodicity.

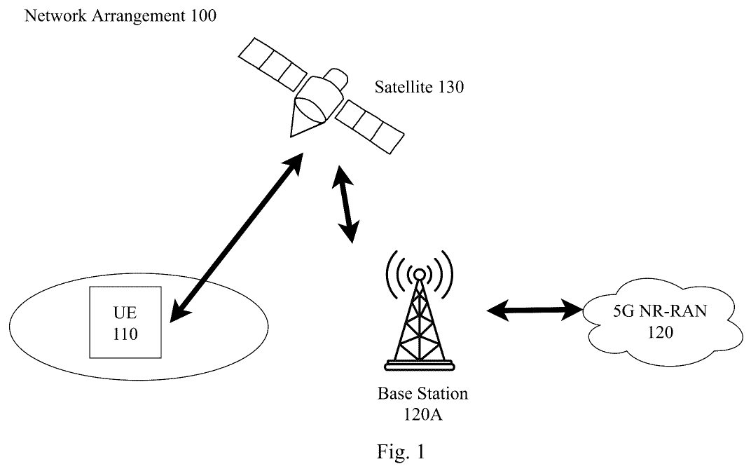

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., head mounted display (HMD), AR glasses, etc.), Internet of Things (IOT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with at least the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120.

The UE 110 may connect to the gNB 120A via a satellite 130. The satellite 130 may communicate with the UE 110 via a service link or a wireless interface. The satellite 130 may further communicate with the gNB 120A via a feeder link or a wireless interface. In some embodiments, the satellite 130 may operate as a passive or transparent network relay node between the UE 110 and the gNB 120A. Those skilled in the art will understand that any association procedure may be performed for the satellite 130 to connect to the UE 110 and the gNB 120A.

Those skilled in the art will understand that the network arrangement 100 may also include various other networks and components such as a cellular core network, the Internet, an IP Multimedia Subsystem (IMS), etc. However, these other networks/components are not relevant to the exemplary embodiments and are therefore not described in any greater detail.

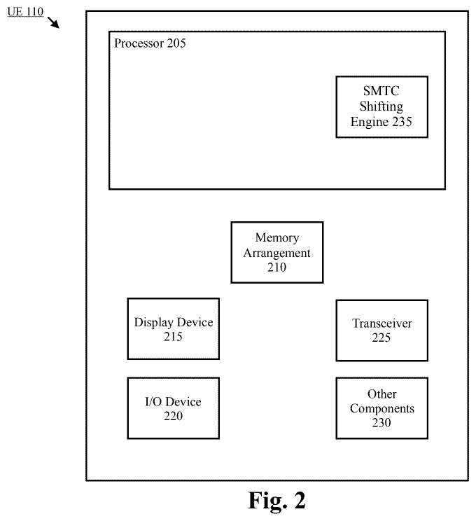

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include an SMTC shifting engine 235. The SMTC shifting engine 235 may perform various operations related to the exemplary receiving SMTC information associated with a specific satellite, performing satellite detection in an SMTC window at time (T1) and shifting the SMTC window based on SMTC information received from the network in a specific direction to avoid SMTC window overlap in the SMTC periodicity. These operations will be described in greater detail below.

The above referenced engine 235 being an application (e. g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

As described above, the exemplary embodiments relate to introducing techniques performed by the UE for shifting SMTC windows associated with a satellite in an SMTC window in NTN. In some exemplary embodiments, the network may configure the SMTC information associated with specific satellite for the UE. In one option, the network may configure one SMTC with one satellite. In another option, the network may configure one SMTC index with one satellite group. Those skilled in the art will understand that these configurations are not limited to these only and that other configurations may be configured for the UE. Thus, in the exemplary embodiment, the UE may perform the SMTC window shifting based on the SMTC configuration received from the network. In other exemplary embodiments, the network may configure SMTC windows to the UE without any association between the SMTC information and satellite within the SMTC windows. Thus, in these exemplary embodiments, the UE may perform a satellite detection within the SMTC window and perform the SMTC window shifting based on the detected satellite associated with the SMTC window using various operations as will be described in more details below.

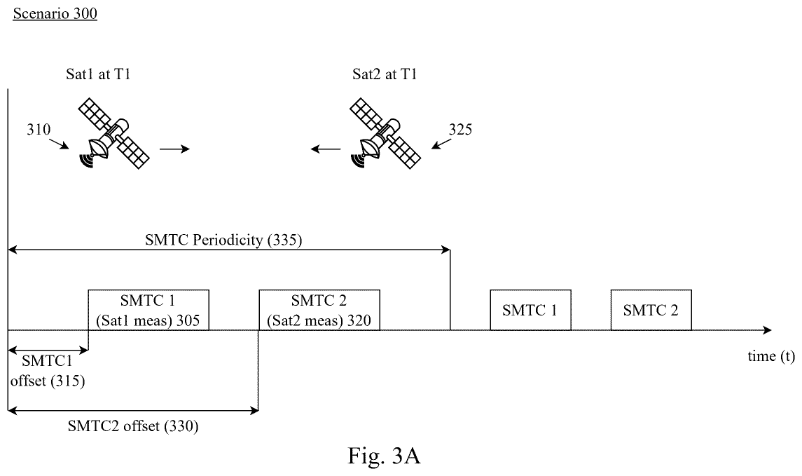

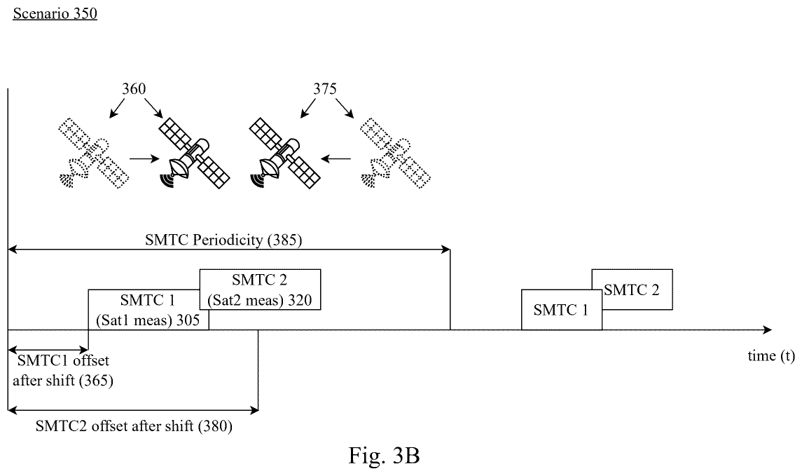

FIG. 3A shows a first exemplary scenario 300 where the UE receives an SMTC measurement configuration from the network according to various exemplary embodiments. FIG. 3A will be described with regard to the network arrangement 100 of FIG. 1 and the UE 110 of FIG. 2.

As shown in FIG. 3A, the network may provide SMTC information for a carrier on the UE 110 in the form of an SMTC measurement configuration. The SMTC measurement configuration may be received by the UE 110 via a system information block (SIB). In this exemplary scenario 300, SMTC measurement configuration may include an SMTC periodicity 335 that includes a first SMTC window 305 (with an SMTC offset 310) and a second SMTC window 320 (with an SMTC offset 330). As shown in FIG. 3, if the SMTC windows 305 and 320 were not shifted, the SMTC windows 305 and 320 will repeat in every SMTC periodicity at the same time. In this example, the SMTC measurement configuration may or may not include an association between a satellite and the corresponding SMTC window. For example, if the SMTC measurement configuration includes satellite information corresponding to the SMTC windows 305 and 320, the UE 110 will be provided with information indicating that the satellite 310 corresponds to the SMTC window 305 and the satellite 325 corresponds to the SMTC window 320, e.g., the UE 110 will receive SMTC information from the satellite in the corresponding SMTC window. If the SMTC measurement configuration does not include satellite information corresponding to the SMTC windows, the UE 110 will perform blind detection to determine which satellite is transmitting SMTC information during the SMTC windows 305 and 320.

In either case, in this example, the UE 110 will determine that the satellite 310 transmits SMTC information during the SMTC window 305 and the satellite 325 SMTC information during the SMTC window 320. As those skilled in the art will understand, the SMTC information for the satellites may include various information about the satellites including, for example, a trajectory the satellite is moving in, a speed the satellite is moving, etc.). For example, FIG. 3 shows a trajectory for each of the satellites 310 and 325. From this information, the UE 110 may understand that the SMTC window corresponding to the satellite may have to be shifted within the SMTC periodicity 335 for the UE 110 to continue to detect the SMTC information transmitted by the satellite.

FIG. 3B shows a second exemplary scenario where the UE receives an SMTC measurement configuration from the network and shifts SMTC windows according to various exemplary embodiments. It should be understood that FIG. 3B shows the same SMTC as FIG. 3B but at a later time, e.g., the SMTC periodicity 335 in FIG. 3B is subsequent to the SMTC periodicity in FIG. 3A. The SMTC windows 305 and 320 in FIG. 3B are the SMTC windows 305 and 320 of FIG. 3A but they have been time shifted as described below. The satellites 310 and 325 are the same as in FIG. 3A. However, in this example, it may be considered that the satellites have moved since the scenario in FIG. 3A. Thus, in FIG. 3B, the UE has used the SMTC information collected during the SMTC windows 305 and 320 to shift the SMTC windows 305 and 320 within the SMTC periodicity 335 as shown in FIG. 3B. In this example, the SMTC windows 305 and 320 have been shifted such that they overlap at the time of FIG. 3B. However, this is only for illustrative purposes, depending on the SMTC information, the SMTC windows 305 and 320 may or may not overlap at any particular time. In this example, the overlap is shown because, at the time of FIG. 3B, the UE 110 cannot measure the SMTC information for both satellites 310 and 325, e.g., the UE 110 does not have the capability to simultaneously measure satellites 310 and 325 during overlapping SMTC windows.

Thus, the exemplary embodiments provide manners of handling scenarios where SMTC window shifting may result in overlapping windows as shown in FIG. 3B. As described above, in some exemplary embodiments, the SMTC measurement configuration provided by the network (e.g., in the SIB) will indicate the association between SMTC information and a specific satellite. The SMTC information may include the SMTC window size, SMTC periodicity, offset and SMTC index. Thus, in the examples of FIGS. 3A and 3B, the SMTC information may include information indicating that the satellite 310 corresponds to the SMTC window 305 and the satellite 325 corresponds to the SMTC window 320.

In these exemplary embodiments, the network will prioritize one of the satellites, e.g., either satellite 310 or 325. The UE will measure/detect the prioritized satellite in the corresponding SMTC window. For example, if the satellite 310 is prioritized, the UE 110 will detect the SMTC information during the SMTC window 305. Based on this SMTC information, the UE 110 will shift the SMTC window 305 within the SMTC periodicity 335 as shown, for example, in FIG. 3B and continue to measure/detect the SMTC information for the satellite 310 during the SMTC window 305. The UE 110 may measure/detect the satellite 325 in the SMTC window 320. However, where the SMTC windows 305 and 320 overlap, the UE 110 will ignore measuring the satellite 325, e.g., the UE 110 will measure/detect the prioritized satellite 310.

As described above, the SMTC window 305 may be shifted based on the SMTC information received from the satellite 310. This SMTC information that is used for SMTC window shifting may be referred to as ephemeris information (satellite moving) of the satellite 310.

In the above examples, it was considered that the SMTC configuration information associated a single satellite with a single SMTC window. However, in other exemplary embodiments, the SMTC configuration information may associate a satellite group (e.g., one or more satellites) with one SMTC window. For example, it may be considered in FIG. 3 that satellite 310 is two satellites (e.g., satellite 310a and satellite 310b). Thus, in this example, the satellites 310a and 310b may both be associated with the SMTC window 305, e.g., the UE 110 may measure/detect SMTC information for the satellites 310a and 310b during the SMTC window 305. In this scenario, the exemplary embodiment described above may also be applied, e.g., instead of a single satellite being prioritized, a satellite group may be prioritized and that satellite group will always be measured during the corresponding SMTC window regardless of where the SMTC window is shifted within the SMT periodicity 335.

The network may determine the satellite group based on the ephemeris information of multiple satellites. For example, the satellites may be configured in one group if the trajectory of those satellites are same. In another example, the satellites may be configured in one group if the distance between those satellites and the UE 110 are within a certain range, e.g., the distance delta between {distance between the satellite 310a and the UE 110} and {distance between the satellite 310b and the UE 110} are below certain threshold. In a further example, the satellites may be configured in one group if the satellites are in geosynchronous orbits (GSO) and can be detected by the UE 110 in one single SMTC window. In an additional example, the satellites may be configured in one group if the distance among the satellites are within certain range (e.g., the satellites are in a certain small area).

If the satellites in the same groups are non-GSO (NGSO), the UE 110 can simultaneously measure/monitor X satellites in this group based on the existing UE capability of “25-5 Parallel measurements on multiple NGSO satellites within a SMTC”.

In other exemplary embodiments, the SMTC configuration information received from the network may not include the association information between the satellites and the SMTC windows. In these exemplary embodiments, the UE 110 performs satellite detection in all configured SMTC windows at T1 (e.g., at the time of FIG. 3A). The UE 110 then determines which satellites are associated with which SMTC window, e. g., in the example of FIG. 3A, the satellite 310 is detected in the SMTC window 305 and the satellite 325 is detected in the SMTC window 320. The UE 110 may then store this association based on the first detection for future measurement and SMTC window shifting.

In these exemplary embodiments, the UE 110 will determine one satellite as a reference satellite of this SMTC, and the SMTC window shifting will be based on this reference satellite. Thus, the difference between the above exemplary embodiments and these exemplary embodiments is that in the above exemplary embodiments, the network selected the reference satellite (e.g., prioritized satellite), whereas in these exemplary embodiments, the reference satellite is determined by the UE 110.

The UE 110 may determine the reference satellite based on any factor or combination of factors. To provide some examples, the UE 110 may select the reference satellite based on the satellite with strongest Reference Signal Received Power (RSRP), Reference Signal Received Quality (RSRQ) or Signal to Noise Ratio (SINR) measured by UE. In another example, the UE 110 may select the reference satellite based on the satellite that has the shortest distance to the UE 110 in this SMTC. In a further example, the UE 110 may select the reference satellite based on the serving satellite if serving satellite is also in this SMTC. In an additional example, the UE 110 may select the reference satellite based on the satellite that has the lowest velocity in this SMTC.

Similar to the above example, in these exemplary embodiments it may be considered that an SMTC window may be for a group of satellites rather than a single satellite. In this example, the UE 110 will determine the SMTC window shifting based on the trajectory of the majority of satellites in the SMTC. For example, if the UE detected M+N satellites in SMTC 1 at T1 (e.g., the time of FIG. 3A), where M satellites share the same trajectory, while the other N satellites share the same trajectory different from those M satellites, the SMTC window shifting will be based on the M satellites ephemeris information if M>N.

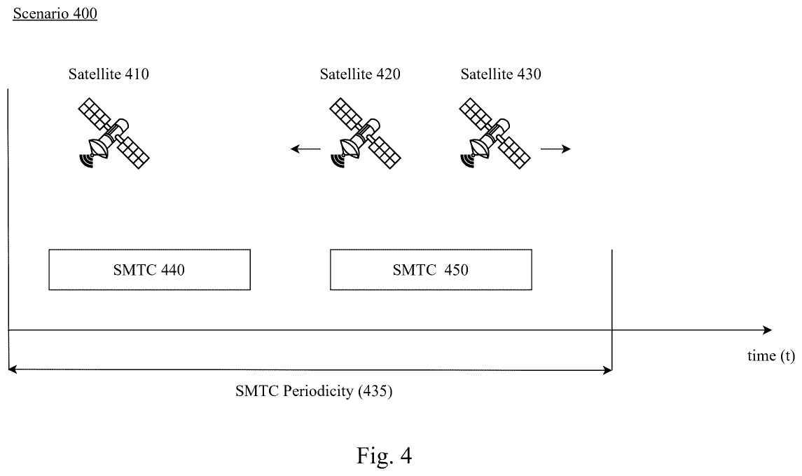

FIG. 4 shows a third exemplary scenario 400 where the UE performs SMTC window shifting based on the SMTC information received from the network according to various exemplary embodiments. In this example, it may be considered that the SMTC configuration information received from the network may not include the association information between the satellites and the SMTC windows. Thus, the UE 110 performs satellite detection in all configured SMTC windows at T1 and then determines which satellites are associated with which SMTC window. In this example, a satellite 410 is associated with the SMTC window 440 and satellites 420 and 430 are associated with the SMTC window 450 in the SMTC periodicity 435. The UE 110 may then store this association based on the first detection for future measurement and SMTC window shifting.

As shown in FIG. 4, the satellites 420 and 430 are both associated with the SMTC window 450. In this example, it may be considered that each of the satellites 410-430 are moving and thus the SMTC windows 440 and 450 will be shifted by the UE 110. However, in this example, it may be considered that the satellites 420 and 430 are moving in different trajectories, e.g., in opposite directions, at much different speeds, etc. Thus, when the UE 110 receives the SMTC information from the satellites 420 and 430, the UE 110 will determine that the associated SMTC window 450 may have to be shifted differently for the satellite 420 and the satellite 430. Since the UE 110 will not create a new SMTC window, the UE 110 will determine whether the SMTC window 450 should be shifted based on the Satellite 420 or the satellite 430.

In these exemplary embodiments, the UE 110 may use the SMTC information received for the satellites 410-430 to determine the future SMTC window shifting operations that will be performed by the UE 110, e.g., based on the ephemeris information for each of the satellites 410-430. Using this information, the UE 110 may determine the SMTC window shifting that will occur for the SMTC window 440 associated with the satellite 410, the SMTC window 450 associated with the satellite 420 and the SMTC window 440 associated with the satellite 430. Based on this information, the UE 110 may determine whether shifting the SMTC window 440 will overlap with the shifting of the SMTC window 450 for either of the satellites 420 or 430. Thus, if the UE 110 determines that there will be no overlap for one of the satellites, e.g., the shifting of the SMTC window 450 for satellite 430 does not result in any overlap with the shifting of the SMTC window 440, the UE 110 will shift the SMTC windows 440 and 450 in accordance with the SMTC information for the satellites 420 and 430, respectively. Thus, in this example, the satellite 420 and its corresponding movement will be ignored.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method performed by a user equipment (UE), comprising:
receiving a synchronization signal (SS)/Physical Broadcast Channel (PBCH) block measurement timing information (SMTC) configuration information comprising at least two SMTC windows within an SMTC periodicity;
determining an association between a first satellite and a first one of the SMTC windows and a second satellite and a second one of the SMTC windows;
receiving first SMTC information for the first satellite during the first one of the SMTC windows and second SMTC information for the second satellite during the second one of the SMTC windows; and
determining a first time shift for the first one of the SMTC windows within the SMTC periodicity based on the first SMTC information and a second time shift for the second one of the SMTC windows within the SMTC periodicity based on the second SMTC information.

2. The method of claim 1, wherein the SMTC configuration information comprises an SMTC window size for the first one and second one of the SMTC windows, an offset for each of the first one and second one of the SMTC windows and an SMTC index for each of the first one and second one of the SMTC windows.

3. The method of claim 1, wherein determining the association between the first satellite and the first one of the SMTC windows and the second satellite and the second one of the SMTC windows is based on association information included in the SMTC configuration information.

4. The method of claim 3, wherein the SMTC configuration information further comprises an indication that one of the first or second satellites is a reference satellite, the method further comprising:
when a shifted first one and second one of the SMTC windows overlap in time, measuring SMTC signals sent by the reference satellite and ignoring SMTC signals sent by the other one of the satellites.

5. The method of claim 4, wherein the first satellite is a first group of satellites and the second satellite is a second group of satellites, wherein the first time shift is based on the SMTC information from any one of the first group of satellites and the second time shift is based on the SMTC information from any one of the second group of satellites.

6. The method of claim 5, wherein the first and second group of satellites are grouped based on one of (a) a trajectory of each of the satellites, (b) a distance between each of the satellites and the UE, (c) whether the satellites are in geosynchronous orbits (GSO) and can be detected by the UE in a single SMTC window, or (d) a distance between each of the satellites.

7. The method of claim 1, wherein determining the association between the first satellite and the first one of the SMTC windows and the second satellite and the second one of the SMTC windows, comprises:
detecting SMTC information in each of the first one and the second one of the SMTC windows;
determining the first SMTC information detected in the first one of the SMTC windows corresponds to the first satellite;
determining the second SMTC information detected in the second one of the SMTC windows corresponds to the second Satellite; and
storing the association between the first satellite and the first one of the SMTC windows and the second satellite and the second one of the SMTC windows.

8. The method of claim 7, further comprising:
selecting one of the first or second satellites as a reference satellite; and
when a shifted first one and second one of the SMTC windows overlap in time, measuring SMTC signals sent by the reference satellite and ignoring SMTC signals sent by the other one of the satellites.

9. The method of claim 8, wherein selecting the reference satellite is based on at least one of (a) a Reference Signal Received Power (RSRP), (b) a Reference Signal Received Quality (RSRQ), (c) a Signal to Noise Ratio (SINR), (d) a distance between the first and second satellites and the UE, (e) whether the first or second satellite is a serving satellite, or (f) a velocity of the first or second satellites.

10. The method of claim 8, wherein the first satellite comprises a first group of satellites and a second group of satellites,
wherein the first time shift is based on a number of satellites in the first group of satellites that share a same trajectory,
wherein the second time shift is based on a number of satellites in the second group of satellites that share a same trajectory,
wherein the number of satellites in the first group of satellites is not less than the number of satellites in the second group of satellites.

11. The method of claim 7, wherein the second satellite comprises the second satellite transmitting the second SMTC information and a third satellite transmitting third SMTC information detected in the second one of the SMTC windows, wherein determining the second time shift for the second one of the SMTC windows within the SMTC periodicity comprises:
determining the second time shift for the second one of the SMTC windows based on the second SMTC information; and
determining the second time shift for the second one of the SMTC windows based on the third SMTC information.

12. The method of claim 11, further comprising:
determining whether the shifted first one of the SMTC windows overlaps with the second one of the SMTC windows that was shifted based on the second SMTC information; and
determining whether the shifted first one of the SMTC windows overlaps with the second one of the SMTC windows that was shifted based on the third SMTC information.

13. The method of claim 12, further comprising:
using the second one of the shifted SMTC windows that does not overlap with the shifted first one of the SMTC windows.

14. One or more processors configured to:
receive a synchronization signal (SS) / Physical Broadcast Channel (PBCH) block measurement timing information (SMTC) configuration information comprising at least two SMTC windows within an SMTC periodicity;
determine an association between a first satellite and a first one of the SMTC windows and a second satellite and a second one of the SMTC windows;
receive first SMTC information for the first satellite during the first one of the SMTC windows and second SMTC information for the second satellite during the second one of the SMTC windows; and
determine a first time shift for the first one of the SMTC windows within the SMTC periodicity based on the first SMTC information and a second time shift for the second one of the SMTC windows within the SMTC periodicity based on the second SMTC information.

15. The one or more processors of claim 14, wherein determining the association between the first satellite and the first one of the SMTC windows and the second satellite and the second one of the SMTC windows is based on association information included in the SMTC configuration information.

16. The one or more processors of claim 15, wherein the SMTC configuration information further comprises an indication that one of the first or second satellites is a reference satellite, the one or more processors further configured to:
when a shifted first one and second one of the SMTC windows overlap in time, measure SMTC signals sent by the reference satellite and ignoring SMTC signals sent by the other one of the satellites.

17. The one or more processors of claim 14, wherein the one or more processors determine the association between the first satellite and the first one of the SMTC windows and the second satellite and the second one of the SMTC windows by:
detecting SMTC information in each of the first one and the second one of the SMTC windows;
determining the first SMTC information detected in the first one of the SMTC windows corresponds to the first satellite;
determining the second SMTC information detected in the second one of the SMTC windows corresponds to the second satellite; and
storing the association between the first satellite and the first one of the SMTC windows and the second satellite and the second one of the SMTC windows.

18. The one or more processors of claim 17, further configured to:
select one of the first or second satellites as a reference satellite; and
when a shifted first one and second one of the SMTC windows overlap in time, measure SMTC signals sent by the reference satellite and ignoring SMTC signals sent by the other one of the satellites.

19. The one or more processors of claim 17, wherein the second satellite comprises the second satellite transmitting the second SMTC information and a third satellite transmitting third SMTC information detected in the second one of the SMTC windows, wherein the one or more processors determine the second time shift for the second one of the SMTC windows within the SMTC periodicity by:
determining the second time shift for the second one of the SMTC windows based on the second SMTC information; and
determining the second time shift for the second one of the SMTC windows based on the third SMTC information.

20. The one or more processors of claim 19, further configured to:
determine whether the shifted first one of the SMTC windows overlaps with the second one of the SMTC windows that was shifted based on the second SMTC information;
determine whether the shifted first one of the SMTC windows overlaps with the second one of the SMTC windows that was shifted based on the third SMTC information; and
use the second one of the shifted SMTC windows that does not overlap with the shifted first one of the SMTC windows.
